(19) United States
(12) Patent Application Publication
(10) Pub. No.: US 2010/0075756 A1
(43) Pub. Date: Mar. 25, 2010

(54) Secondary controller for emulating a console controller

(76) Inventors: Adam Roberts, Moncure, NC (US); Donna Hardee, Raleigh, NC (US); Christopher J. Hardee, Raleigh, NC (US)

Correspondence Address: HOLMAN IP LAW/IBM RSW, 175 S Main Street, Suite #850, Salt Lake City, UT, 84111, US

(21) Appl. No.: 12/234,415

(22) Filed: Sep. 19, 2008

(51) Int. Cl. G06F 17/00

(52) U.S. Cl. 463/39

(57) ABSTRACT

An apparatus for emulating a console controller. The apparatus includes a console connector of a secondary controller, an input interface, and an output interface. The console connector of the secondary controller connects the secondary controller to a console controller. The secondary controller connects to a gaming console through the console controller. The input interface couples to the console connector. The input interface generates an input signal in response to a user input at the secondary controller. The output interface couples to the input interface. The output interface receives the input signal from the input interface, generates an output signal from the input signal, and sends the output signal to the gaming console through the console controller.

### BACKGROUND

Current generation gaming consoles implement a proprietary method of controlling gaming functions. Typically, a user controls a function of the gaming console via some kind of proprietary console controller. Gaming consoles have several controller inputs that are common between them. Most common are two firing trigger pairs on the left and right front of the controllers as well as two directional devices. A first directional device may change direction of a character's movement while a second may change a perspective independent of the character's movement. In other words, one may change the direction of the character's physical motion while the other changes the direction of the character's perspective, or virtual view. Hence, the proprietary console controller may employ two or more trigger buttons as well as two or more directional input devices such as a thumb pad and/or a thumb joystick. A game played on the gaming console is written and executed on the gaming console such that a user input from one of the trigger buttons and/or direction input devices of the proprietary console controller results in a triggering of a function in the game and/or a directional function. Typically, the proprietary console controller and third party clones of the proprietary console controller are the only means for controlling a function of gaming software running on the gaming console.

Many personal computer (PC) game players, or gamers, have not made a switch to playing games on a gaming console due to the lack of a universal mouse controller that easily ports from one type of gaming console to another, or from a PC to a gaming console. A PC mouse device could be used to control a function of the gaming console, but games that are already released into the market are not easily modified after they are released. In order to use a PC mouse on a gaming console, software titles would have to add driver support to PC mouse inputs and gaming consoles would have to add hardware and driver support for a PC mouse connection and functionality.

Revenue for gaming consoles and for games specific to gaming consoles are limited due to the limited availability of controller options on conventional gaming consoles. Offering one type of proprietary controller to control functions of games on gaming consoles limits the choices a game player may have in controlling the functions of the gaming console. Increasing the number of controller options that may be used on a gaming console beyond the proprietary controller would help to increase the controller options of a game player as well as to expand market appeal of the gaming console type of games and thereby increase gaming console related revenues.

### SUMMARY

Embodiments of an apparatus are described. In one embodiment, the apparatus is a secondary controller for emulating a console controller. An embodiment of the secondary controller includes a console connector of a secondary controller, an input interface, and an output interface. The console connector of a secondary controller connects the secondary controller to a console controller. The secondary controller connects to a gaming console through the console controller. The input interface couples to the console connector. The input interface generates an input signal in response to a user input at the secondary controller. The output interface couples to the input interface. The output interface receives the input signal from the input interface, generates an output signal from the input signal, and sends the output signal to the gaming console through the console controller. Other embodiments of the apparatus are also described.

Embodiments of a system are also described. In one embodiment, the system is a system of a console controller connected to a secondary controller. The system includes a console controller, a console connector, and a controller pass-thru device. The console controller connects to a gaming console and receives an emulation signal from a secondary controller. The emulation signal is compatible with a signal type of the console controller. The console connector connects the secondary controller to the console controller. The console controller connects the secondary controller to the gaming console. The controller pass-thru device replaces the emulation signal from the secondary controller with a response signal and sends the response signal to the gaming console. Other embodiments of the system are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a gaming system.

FIG. 2 depicts a schematic block diagram of an example embodiment of the secondary controller of the gaming system of FIG. 1.

FIG. 3 depicts a schematic flow chart diagram of one embodiment of a method of a secondary controller generating an output signal that is compatible with a console controller signal type.

FIG. 4 depicts a schematic flow chart diagram of one embodiment of a method for implementing a profile selection for the input interface of the secondary controller of FIG. 2.

FIG. 5 depicts a schematic flow chart diagram of one embodiment of a method for implementing an output mode selection for the output interface of the secondary controller of FIG. 2.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments facilitate emulating a console controller signal type in a secondary controller attached to a console controller. The emulation signal generated by the secondary controller is intercepted by the console controller. The emulation signal emulates an input on the console controller by a user. Hence, the console controller interprets the emulation signal as a regular input to the console controller by a user and generates the appropriate response signal to the emulated input. The console controller then sends the response signal to a gaming console that is also attached to the console controller. The gaming console receives the response signal and interprets the response signal as a console controller type of signal. In other words, the emulation signal is interpreted by the console controller as originating from an input by the user. Emulating a console controller signal type in a secondary controller allows a user to implement other types of controllers such as a mouse and/or a keyboard on a gaming console without any hardware, firmware, and/or software modification to the gaming console and/or gaming software. Some embodiments of the secondary controller include a driverless signal emulating controller that, when used with a specially prepared console controller, controls the most typical gaming inputs without changing the gaming console firmware or implementing a USB driver. Some embodiments of the secondary controller include a complete hardware emulation of the console controller. Hence, a single secondary controller may be universally implemented for all types of gaming consoles without a firmware update for controllers, drivers, and/or game patches.

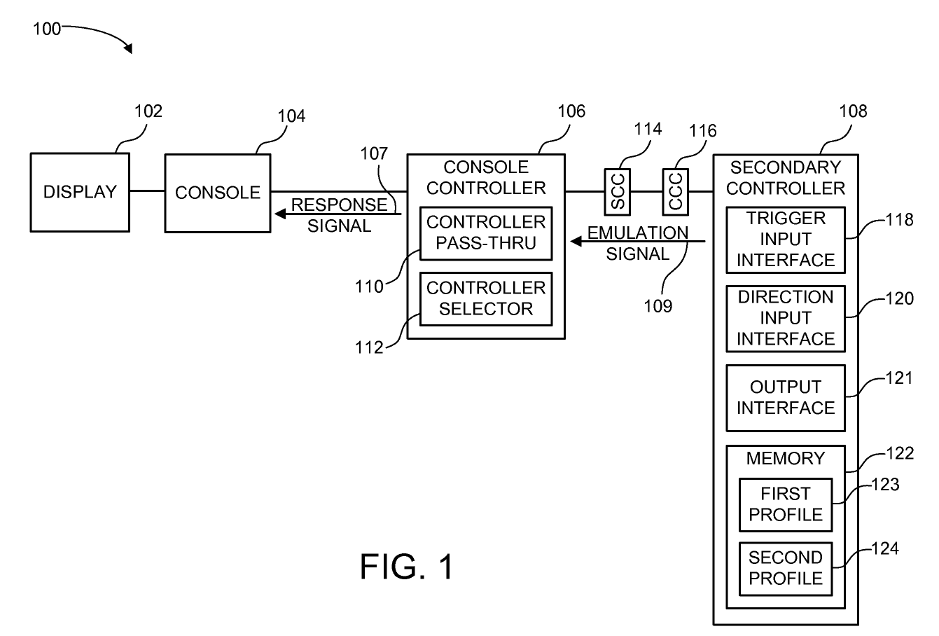

FIG. 1 depicts a schematic block diagram of one embodiment of a gaming system 100. The gaming system 100 includes a display device 102, a gaming console 104, a console controller 106, and a secondary controller 108. Additionally, the console controller 106 a controller pass-thru 110, a controller selector 112, and a secondary controller connector 114. As illustrated, the console controller 106 generates a response signal 107. Additionally, the secondary controller 108 includes a trigger input interface 118, a direction input interface 120, an output interface 121, and a memory device 122. As illustrated, the secondary controller 108 generates an emulation signal 109. Furthermore, some embodiments of the memory device 122 store a first profile 123 and a second profile 124. It should be noted that the configurations of the display device 102, the gaming console 104, the console controller 106, and secondary controller 108 are not limited to particular hardware or software implementations.

Although the depicted gaming system 100 is shown and described herein with certain components and functionality, other embodiments of the gaming system 100 may be implemented with fewer or more components or with more or less functionality. For example, some embodiments of the gaming system 100 include two or more console controllers 106 and/or two or more secondary controllers 108. Additionally, some embodiments of the gaming system 100 include similar components arranged in another manner to provide similar functionality, in one or more aspects. For example, some embodiments of the gaming system 100 integrate, at least partially, some or all of the components depicted in the gaming system 100 into a single gaming device.

The illustrated display device 102 displays a function of the gaming console 104. For example, the display device 102, in some embodiments, displays a video game that is played on the gaming console 104. Hence, in some embodiments, the display device 102 displays a result of a signal generated by the secondary controller 108 in response to a user input on the secondary controller 108.

In one embodiment, the gaming console 104 executes gaming software for display on the display device 102. Furthermore, the gaming console 104 receives and processes signals from the console controller 106 and/or the secondary controller 108. For example, the gaming console 104, in some embodiments, receives a signal generated by the secondary controller 108 in response to a user input on the secondary controller 108, processes the signal generated by the secondary controller 108, and instructs the display device 102 to display the result of the processed signal. Additionally, the gaming console 104 may generate a feedback signal in relation to the gaming software. Hence, in some embodiments, the gaming console 104 generates a feedback signal and sends the feedback signal to the console controller 106 and/or to the secondary controller 108 through the console controller 106.

In one embodiment, the console controller 106 is configured to connect to the gaming console 104. Additionally, the console controller 106 intercepts the emulation signal 109 from the secondary controller 108, replaces the emulation signal 109 with the response signal 107, and sends the response signal 107 to the gaming console 104. The emulation signal 109 is configured to emulate a particular input by a user on the console controller 106. For example, when a user pushes a certain button on the console controller 106 the console controller 106 generates a response signal 107 that corresponds to the user pushing the certain button of the console controller 106 and the response signal 107 is sent by the console controller 106 to the gaming console 104. Likewise, when the user pushes a certain button on the secondary controller 108, the secondary controller 108 generates an emulation signal 109 that emulates the user pushing the corresponding certain button of the console controller 108. The console controller 106 intercepts the emulation signal 109 from the secondary controller 108 which triggers the console controller 106 to generate an appropriate response signal 107 corresponding to the emulated input. In other words, the console controller 106 intercepts the emulation signal 109 from the secondary controller 108, replaces the emulation signal 109 with the response signal 107, and sends the response signal 107 to the gaming console 104. The gaming console 104 then interprets the response signal 107 as an input by a user on the console controller 106 when in fact the user initiates the generation of the input on the secondary controller 108.

The controller pass-thru device 110 electrically connects the secondary controller 108 to the console controller 106. In other words, the controller pass-thru device 110 receives the emulation signal 109 from the secondary controller 108, and converts the emulation signal 109 to the response signal 107. Hence, the controller pass-thru device 110 electrically connects the secondary controller 108 to the gaming console 102. In some embodiments, the controller pass-thru device 110 is further configured to receive a feedback signal intended for the secondary controller 108 from the gaming console 104 and to send the feedback signal through the console controller 106 to the secondary controller 108. Alternatively, in some embodiments, the controller pass-thru device 110 receives a feedback signal intended for the console controller 108 and receives the feedback signal at the console controller 106 for processing by the console controller 106.

In one embodiment, the controller selector 112 selects among a selection of operating modes. For example, the console controller 106 may include a first operating mode for singular operation of the secondary controller 108. In the first operating mode, the secondary controller 108 generates an input signal for each received user input, while the console controller 106 does not respond to any user input. In other words, in the first operating mode, the user input functions of the console controller 106 are disabled while the user input functions of the secondary controller 108 are enabled. The console controller 106 may also include a second operating mode for singular operation of the console controller 106. In the second operating mode, the console controller 106 generates an input signal for each received user input, while the secondary controller 108 does not respond to any user input. In other words, in the second operating mode, the user input functions of the secondary controller 108 are disabled while the user input functions of the console controller 106 are enabled. Additionally, the console controller 106 may also include a third operating mode for mutual operation of the console controller 106 and the secondary controller 108. In the third operating mode, the console controller 106 generates an input signal for each received user input on the console controller 106 and the secondary controller 108 generates an input signal for each received user input on the secondary controller 108. In other words, in the third operating mode, the user input functions of the console controller 106 and the secondary controller 108 are enabled.

The controller selector 112 may be further configured to implement a priority between a signal generated by the console controller 106 such as the response signal 107 and the emulation signal 109 generated by the secondary controller 108. In one embodiment, the controller pass-thru device 110 is configured to send the emulation signal 109 from the secondary controller 108 to the gaming console 104 and to discard the signal type of the console controller 106. Alternatively, in some embodiments, the controller pass-thru device 110 is configured to discard the emulation signal 109 from the secondary controller 108 and to send a signal type of the console controller 106 such as the response signal 107 to the gaming console 104.

In one embodiment, the secondary console connector 114 connects the secondary controller 108 to the console controller 106. In other words, the console controller 106 connects the secondary controller 108 to the gaming console 104 through the secondary console connector 114.

The illustrated secondary controller 108 allows a user to operate another controller in addition to the console controller 106. For example, the secondary controller 108 may include a mouse controller, a keyboard/keypad, a joystick, a steering wheel controller, or any other similar controller. Additionally, the secondary controller 108 may include any combination of the described controllers such as a controller that combines a mouse controller with a keypad device.

The secondary controller 108 includes at least one type of input interface to allow a user to control an aspect of gaming software running on the gaming console 104. Generally, an input interface generates an input signal in response to a user input at the secondary controller 108. In other words, a user presses a button or moves a thumb pad on the secondary controller 108, and the input interface generates an input signal corresponding to the user's press of a button and/or moving of the thumb pad, and so forth. Specifically, the input interface includes a trigger input interface 118 and a direction input interface 120. The trigger input interface 118 includes at least one trigger button to generate a trigger input signal. The direction input interface 120 includes at least one directional device such as a mouse trackball to generate a direction input signal. The direction input signal may include an X-Y signal to indicate movement in the X-Y axis as well as a velocity signal to indicate the speed at which the movement in the X-Y axis occurs.

In one embodiment, the console controller connector 116 connects the secondary controller 108 to the console controller 106. More specifically, the console controller connector 116 connects to the secondary controller connector 114 of the console controller 106. Some embodiments of the secondary controller connector 114 include a socket into which the console controller connector 116 plugs. In other words, the console controller connector 116 allows the secondary controller 108 to connect to the gaming console 104 through the console controller 106. Additionally, the console controller connector 116 is configured to pass signals back and forth between the secondary controller 108 and the gaming console 104, and through the console controller 106. Hence, the console controller connector 116 allows the secondary controller 108 to communicate with the gaming console 104 through the console controller 106.

The output interface 121 is coupled to the input interface (e.g., the trigger input interface 118 and the direction input interface 120) of the secondary controller 108. The output interface 121 receives the input signal from the input interface and generates an output signal from the input signal. The output interface 121 then sends the output signal to the gaming console 104 through the console controller 106.

As illustrated, the secondary controller 108 includes a memory device 122. One embodiment of the illustrated memory device 122 stores a first profile 123 and a second profile 124. In some embodiments, the profiles 123 and 124 store mappings of an output signal to an output line of the console controller connector 116. In one example embodiment, the first profile 123 stores a first mapping of a first output signal to a first output line. The second profile 124 stores a second mapping of the first output signal to a second output line of the console controller connector 116. In other words, in one embodiment, a user customizes the mapping of a certain button on the secondary controller 108 to a certain output signal and stores the customized mapping as a profile in the memory device 122. In some embodiments, the display device 102 displays a user interface to enable the user to customize the mappings between the inputs of the secondary controller 108 and the outputs of the secondary controller 108.

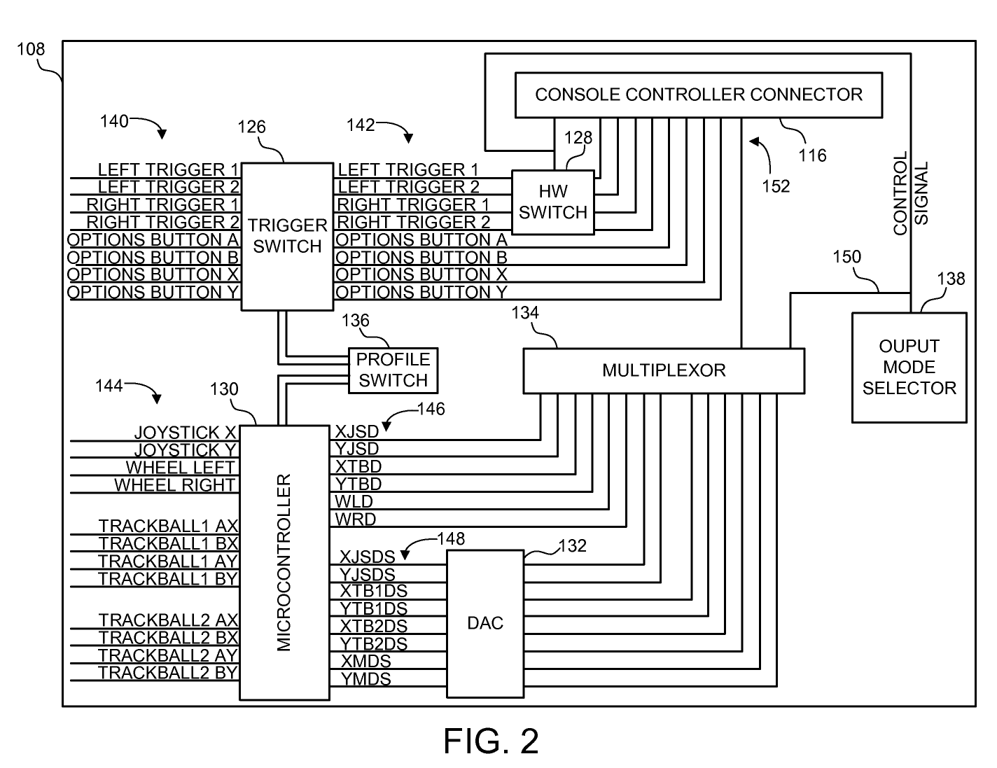

FIG. 2 depicts a schematic block diagram of an example embodiment of the secondary controller 108 of the gaming system 100 of FIG. 1. The illustrated secondary controller 108 includes a trigger switch 126, a hardware switch 128, a microcontroller 130, a digital-to-analog converter (DAC) 132, and a multiplexor 134. Additionally, the secondary controller 108 includes a profile switch 136 and an output mode selector 138. Furthermore, the depiction of the secondary controller 108 includes examples of trigger input signals 140 and trigger output signals 142. Additionally, the depiction of the secondary controller 108 includes examples of directional input signals 144, directional output signals 146, and directional output summation signals 148. Furthermore, as depicted the secondary controller 108 includes examples of a control signal line 150 and output lines 152 of the console controller connector 116.

It should be noted that the configurations of the trigger switch 126, the hardware switch 128, the microcontroller 130, the DAC 132, and the multiplexor 134 are not limited to particular hardware or software implementations. Likewise, the configurations of the profile switch 136, the output mode selector 138, and the various signals 140-148 are not limited to particular hardware or software implementations.

Although the depicted secondary controller 108 is shown and described herein with certain components and functionality, other embodiments of the secondary controller 108 may be implemented with fewer or more components or with more or less functionality. Additionally, at least some of the components depicted as part of the secondary controller 108 may be integrated, at least partially, on an integrated circuit.

In one embodiment, the depicted output interface 121 of FIG. 1 includes at least the trigger switch 126 and the microcontroller 130 depicted in FIG. 2. Some embodiments of the trigger switch 126 and the microcontroller 130 of FIG. 2 operate in conjunction with the trigger input interface 118 and the direction input interface 120, respectively, of FIG. 1. As illustrated, the trigger switch 126 and the microcontroller 130 receive trigger input signals 140 and directional input signals 144, respectively. For example, the trigger switch 126 may receive a trigger input signal 140 such as left trigger 1, left trigger 2, options button A, options button B, and so forth. Additionally, the microcontroller 130 may receive a directional input signal 144 such as joystick X, joystick Y, trackball1 AX, trackball1 BX, and so forth.

Directional input signals 144 trackball1 AX and trackball1 BX may represent, respectively, an X-Y movement and a velocity associated with the X-Y movement. Additionally, the trigger input interface 118 and the direction input interface 120 generate trigger output signals 142 as well as directional output signals 146 and directional output summation signals 148, respectively. For example, the trigger switch 126 may generate trigger output signals 142 such as left trigger 1, left trigger 2, options button A, options button B, and so forth, that correspond to the depicted trigger input signals 140. As depicted, the left trigger 1 input signal maps directly to the left trigger 1 output. As described above, a mapping between an input line and an output line may be modified on demand. In other words, the left trigger 1 input line of the trigger switch 126 may be mapped to the left trigger 2 output line of the trigger switch 126. Mappings between the input and output lines are described below in greater detail with regard to the profile switch 136.

Additionally, the microcontroller 130 generates directional output signals 146 such as the output signals XJSD and YJSD. XJSD and YJSD, respectively, refer to digital (D) outputs in the X and Y direction (X, Y) associated with the joystick (JS). Additionally, the microcontroller 130 generates directional output summation signals 148 such as the output signals XJSDS and YJSDS. XJSDS and YJSDS also refer to digital outputs in the X and Y direction associated with the joystick, but also refer to a summation of the X and Y directional signals generated by the joystick. In other words, a joystick may include a graduated scale of force applied to the joystick. When a user, over a certain time, presses the joystick quickly in the X direction and holds it there for a time and then releases the joystick, a certain number of XJSD signals are generated, measured, and summed into the XJSDS signal. In some embodiments, the XJSD signals are also averaged over the certain time. Similarly, when the user, over the same certain time, then presses the joystick relatively lightly and slowly in the X direction and holds it there for a time and then releases the joystick, then a certain number of XJSD signals are generated, measured and summed into the XJSDS signal. In the second example, the user presses the joystick more lightly and slowly then the first example, and so a larger number of the XJSD signals are smaller. Hence, the summed and averaged XJSDS measures less in the second example then in the first example. Therefore, the directional output summation signals 148 allow a variable control of the directional signals generated by the microcontroller 130.

One embodiment of the illustrated trigger switch 126 receives a trigger input signal from the trigger input interface 118 and maps the trigger input signal to an output signal of the trigger switch 126 as a trigger output signal. The trigger switch 126 sends the trigger output signal to the gaming console 104 through the console controller 106. One embodiment of the trigger input and output signals 140 and 142 each indicate an ON state or an OFF state. For example, a trigger input signal 140 may indicate a firing of a weapon in gaming software, where an ON state indicates a firing of the weapon when a user hits a button of the trigger input interface 118. Alternatively, some embodiments of the trigger input and output signals 140 and 142 indicate an OFF state as well as degrees of ON states. For example, a button of the trigger input interface 118 may indicate a punch in a boxing game, where a half press of the button of the trigger input interface 118 indicates half a measure of a full force punch and a full press of the button of the trigger input interface 118 indicate a full measure of a punch.

The illustrated hardware switch 128, as depicted, electrically connects between at least one of the output lines of the trigger switch 126 and the console controller connector 116. Additionally, the hardware switch 128 electrically connects to the output mode selector 138. In one embodiment, the hardware switch 128 is configured to implement the output mode selection based on a control signal sent over the control signal line 150 from the output mode selector 138. The hardware switch 128, in some embodiments, receives an analog trigger input signal from the trigger switch 126 and passes through the analog trigger input signal. In other words, the hardware switch 128 generates an analog trigger output signal from the analog trigger input signal based on the output mode selection of the output mode selector 138. Alternatively, in some embodiments, the hardware switch is configured to receive an analog trigger input signal from the trigger switch 126 and to switch the analog trigger input signal to a digital output trigger signal. In other words, the hardware switch 128 generates a digital output trigger signal from the analog trigger input signal based on the output mode selection of the output mode selector 138.

The illustrated microcontroller 130, in one embodiment, receives a direction input signal from the direction input interface 120. The illustrated microcontroller 130 generates a direction output signal 146 and/or 148 from the direction input signal 144. In one embodiment, the direction output signal 146 and/or 148 is compatible with a signal that originates from the console controller 106. The microcontroller 130 sends the direction output signal to the gaming console 104 through the console controller 106. The direction input and output signals include an X-Y signal to indicate movement in an X-Y axis as well as a velocity signal associated with the X-Y movement. In other words, the velocity signal indicates the speed at which the movement in the X-Y axis occurs.

In one embodiment, the profile switch 136 selects a profile stored in the memory device 122. In some embodiments, the profile switch 136 includes a switch that includes positions selectable by a user. For example, the profile switch 136 may include at least a first profile position and a second profile position. In one example embodiment, when a user switches the profile switch 136 to the first profile position, the first mapping set associated with the stored first profile 123 is implemented such that the first output signal is mapped to the first output line of the output lines 152, as explained above with reference to the first profile 123 of FIG. 1. Likewise, when the user switches the profile switch 136 to the second profile position, the second mapping set associated with the second profile 124 is implemented such that the first output signal is mapped to the second output line of the output lines 152, as explained above with reference to the second profile 124 of FIG. 1. Hence, in one embodiment, the profile switch 136 selects a profile according to a profile stored in the memory device 122, generates a profile signal based on the selected profile, and sends the profile signal to the trigger switch 126 and/or the microcontroller 130. The profile signal indicates the mapping of the output signal to one of the output lines 152. Thus, the output interface 121 sends the output signal to the console controller 106 over one of the output lines 152 according to the mapping of the selected profile. In one embodiment, the profile switch 136 is configured to switch on demand from the first profile 123 to the second profile 124 stored in the memory device 122. For example, in some embodiments, the profile switch 136 receives a signal from the gaming console 104 to select the second profile 124. The profile switch 136 then generates a second profile signal based on the second profile 124, and sends the second profile signal to the output interface 121 (trigger switch 126 and/or the microcontroller 130). The second profile signal indicates a second mapping of the output signal to a second output line. The output interface 121 then sends the output signal to the console controller 106 over the second output line of the output lines 152 according to the second mapping of the second profile.

The illustrated output mode selector 138, in one embodiment, is configured to select between a digital output mode and an analog output mode of the secondary controller 108. The output mode selector 138 generates a control signal and sends the control signal over the control signal line 150 to indicate the selected output mode. For example, when the digital output mode is selected, the control signal indicates that a signal, which is generated by the secondary controller 108 and sent to the gaming console 104 through the console controller 106, is received by the gaming console 104 in a digital format. Likewise, the analog output mode indicates output signals in an analog format. In some embodiments, the console controller connector 116 and/or the secondary controller connector 114 include a pin with a pull-up resistor (not shown) that electrically connects to the output mode selector 138. The pull-up pin supersedes and/or replaces the output of the output mode selector 136 and keeps the output mode selector 138 in the output mode associated with a pull-up condition, or logic high. For example, the digital output mode may be associated with a pull-up condition, or logic high, and the analog output mode associated with a low level voltage, or logic low, on the control signal line 150. Thus, when the console controller connector 116 and/or the secondary controller connector 114 includes a pull-up pin electrically connected to the output mode selector 138, an output signal generated by the secondary controller 108 is in a digital format.

In one embodiment, the multiplexor implements the output mode selection based on the control signal from the output mode selector 138. In some embodiments, the multiplexor multiplexes a group of output signals from the microcontroller 130 and outputs a multiplex output signal based on the output mode selection.

As depicted, the illustrated digital-to-analog converter (DAC) 132 connects between the multiplexor 134 and the microcontroller 130. In some embodiments, a direction output signal generated by the microcontroller 130 is in a digital format. The DAC 132, in some embodiments, converts a digital output direction signal to an analog output direction signal and sends the analog output direction signal to the multiplexor 134. For example, when the output mode selector 138 selects an analog output mode, the DAC 132 converts a digital signal from the microcontroller 130 to an analog signal. Alternatively, when the output mode selector 138 selects a digital output mode, the DAC 132 passes a digital signal from the microcontroller 130 to the multiplexor 134.

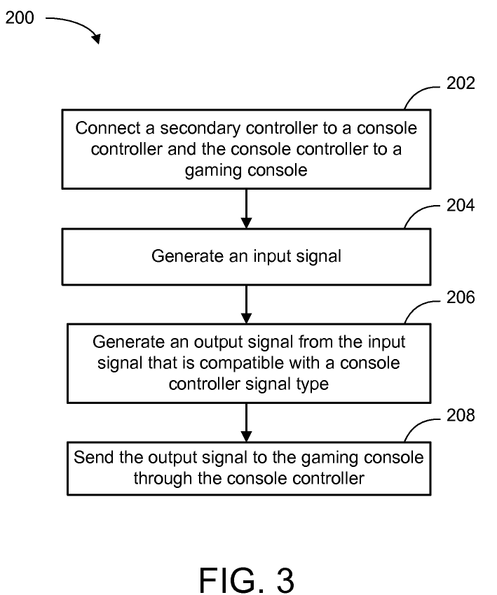

FIG. 3 depicts a schematic flow chart diagram of one embodiment of a method 200 of a secondary controller generating an output signal that is compatible with a console controller signal type. Although the method 200 is described in conjunction with the gaming system 100 of FIG. 1 and components thereof, other embodiments of the method 200 may be implemented with other gaming systems and/or other components thereof.

In one embodiment, at block 202, a user connects the secondary controller 108 to the console controller 106 and the console controller 106 to the gaming console 104. At block 204, the secondary controller 108 generates an input signal in response to an input by the user on the trigger input interface 118 and/or direction input interface 120. At block 206, the output interface 121 receives the input signal and generates an output signal from the input signal. The output signal is compatible with a console controller signal type. In other words, the trigger switch 126 and/or the microcontroller 130 receive the input signal and generate the output signal accordingly. At block 208, the secondary controller 108 sends the output signal to the gaming console 104 through the console controller 106.

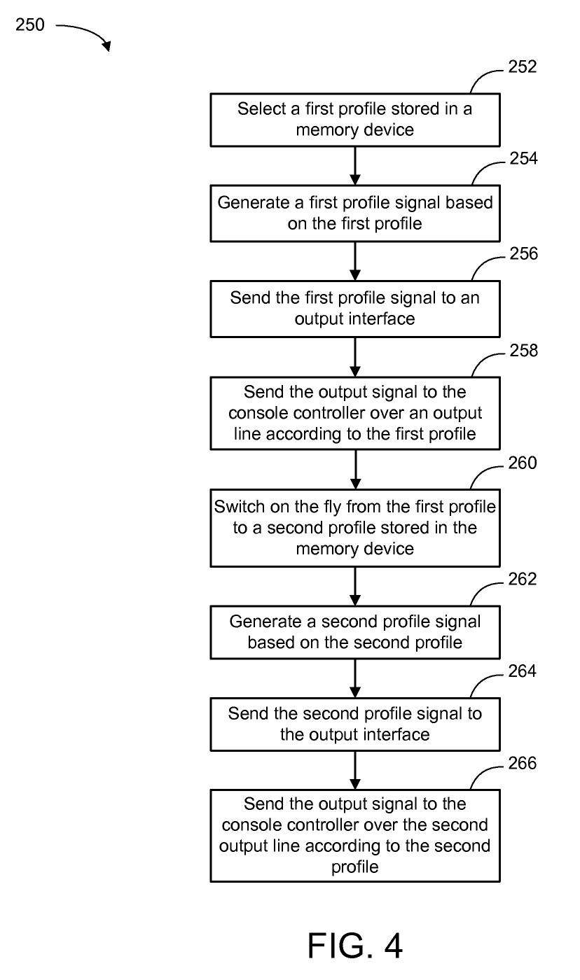

FIG. 4 depicts a schematic flow chart diagram of one embodiment of a method 250 for implementing a profile selection for the input interface of the secondary controller of FIG. 2. Although the method 250 is described in conjunction with the gaming system 100 of FIG. 1 and components thereof, other embodiments of the method 250 may be implemented with other gaming systems and/or other components thereof.

In one embodiment, at block 252, the profile switch 136 selects the first profile 123 stored in the memory device 122. In some embodiments, the selection of the first profile 123 by the profile switch 136 corresponds to a physical selection implemented by a user on the profile switch 136. At block 254, the profile switch 136 generates a first profile signal based on the selected first profile 123. At block 256, the profile switch 136 sends the first profile signal to the output interface 121. In other words, in some embodiments, the profile switch 136 sends the first profile signal to the trigger switch 126 and/or the microcontroller 130. At block 258, the output interface 121 sends the output signal to the console controller 106 over an output line of the console controller connector 116 according to the first profile 123. At block 260, a user switches on the fly from the first profile 123 to the second profile 124 stored in the memory device 122. At block 262, the profile switch 136 generates a second profile signal based on the selected second profile 124. At block 264, the profile switch 136 sends the second profile signal to the output interface 121. The output interface 121, at block 266, then sends the output signal to the console controller 106 over the second output line according to the second profile 124.

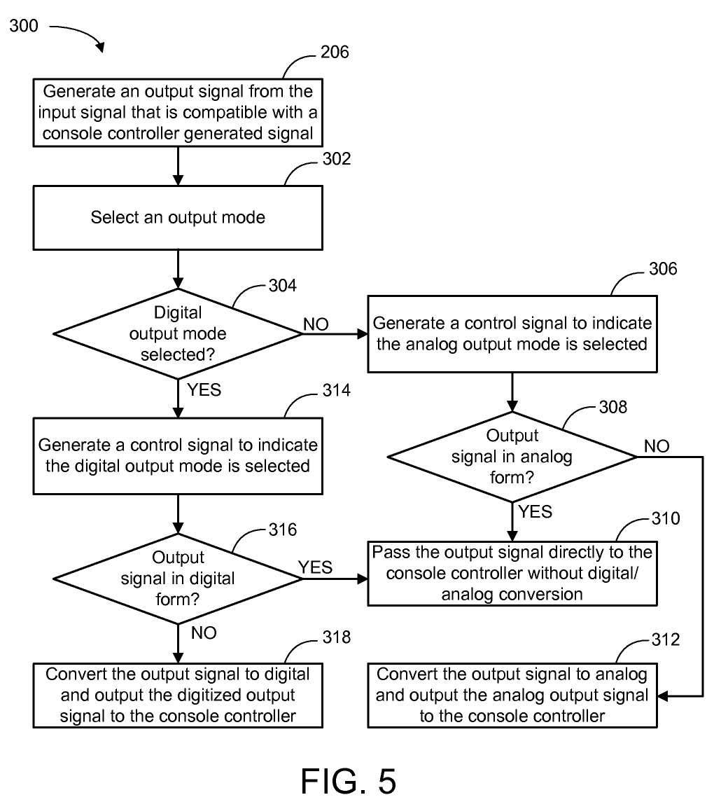

FIG. 5 depicts a schematic flow chart diagram of one embodiment of a method 300 for implementing an output mode selection for the output interface of the secondary controller of FIG. 2. Although the method 300 is described in conjunction with the gaming system 100 of FIG. 1 and components thereof, other embodiments of the method 300 may be implemented with other gaming systems and/or other components thereof.

In one embodiment, the method 300 begins at operation 206 of FIG. 3. As illustrated, at block 302, the output mode selector 138 selects an output mode. As explained above, the output mode selector 138 selects between a digital output mode and an analog output mode. In some embodiments, the selection of the output mode by the output mode selector 138 corresponds to a physical selection implemented by a user on the output mode selector 138. Alternatively, in some embodiments, the selection of the output mode by the output mode selector 138 corresponds to whether or not a pull-up pin is included on the console connector connection 116 that pulls the control signal line 150 high.

At block 304, the output mode selector 138 determines whether the digital output mode is the current output mode selection. If the output mode selector 138 determines that the current output mode selection is not the digital output mode, at block 306, the output mode selector 138 generates a control signal and sends the control signal over the control signal line 150 to indicate the analog output mode is selected. In some embodiments, the output mode selector 138 sends the control signal to the output interface 121, the hardware switch 128, and/or the multiplexor 134. Otherwise, at block 314, the output mode selector 138 generates a control signal to indicate the digital output mode is the current output mode selection.

At block 308, the output interface 121, the hardware switch 128, and/or the multiplexor 134 determine whether an output signal generated by the output interface 121 is in analog form. If the output interface 121, the hardware switch 128, and/or the multiplexor 134 determine that the output signal generated by the output interface 121 is in analog form, at block 310, the output interface 121, the hardware switch 128, and/or the multiplexor 134 pass the output signal directly to the console controller 106 without any digital-to-analog conversion. Otherwise, at block 312, the hardware switch 128 and/or the digital-to-analog converter 132 convert the output signal to analog and send the analog output signal to the console controller 106.

At block 316, the output interface 121, the hardware switch 128, and/or the multiplexor 134 determine whether an output signal generated by the output interface 121 is in digital form. If the output interface 121, the hardware switch 128, and/or the multiplexor 134 determine that the output signal generated by the output interface 121 is in digital form, at block 310, the output interface 121, the hardware switch 128, and/or the multiplexor 134 pass the output signal directly to the console controller 106 without any conversion. Otherwise, at block 318, the output interface 121, the hardware switch 128, and/or the multiplexor 134 convert the output signal to digital and send the digitized output signal to the console controller 106.

Other embodiments of the methods 200, 250, and 300 may implement fewer or more operations. It should also be noted that at least some of the operations for the methods 200, 250, and 300 may be implemented using software instructions stored on a computer useable storage medium for execution by a computer. As an example, an embodiment of a computer program product includes a computer useable storage medium to store a computer readable program that, when executed on a computer, causes the computer to perform operations. In one embodiment, the operations include an operation of a secondary controller generating a signal to control a function of a gaming console. One embodiment of the secondary controller attaches to a console controller. The secondary controller emulates a console controller signal type, and the emulated signal is passed through the console controller to the gaming console.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An apparatus comprising:
a console connector of a secondary controller to connect the secondary controller to a console controller, wherein the secondary controller is configured to connect to a gaming console through the console controller;
an input interface coupled to the console connector, the input interface to generate an input signal in response to a user input at the secondary controller; and
an output interface coupled to the input interface, the output interface to receive the input signal from the input interface, to generate an output signal from the input signal, and to send the output signal to the gaming console through the console controller.

2. The apparatus of claim 1, further comprising a profile switch coupled to the output interface, the profile switch to select a first profile stored in a memory device, to generate a first profile signal based on the first profile, and to send the first profile signal to the output interface, wherein the first profile signal indicates a first mapping of the output signal to a first output line, wherein the output interface is further configured to send the output signal to the console controller over the first output line according to the first mapping of the first profile.

3. The apparatus of claim 2, wherein the profile switch is further configured to switch on demand from the first profile to a second profile stored in the memory device, to generate a second profile signal based on the second profile, and to send the second profile signal to the output interface, wherein the second profile signal indicates a second mapping of the output signal to a second output line, wherein the output interface is further configured to send the output signal to the console controller over the second output line according to the second mapping of the second profile.

4. The apparatus of claim 2, wherein the input interface comprises a direction input interface to generate a direction input signal, wherein the output interface comprises a microcontroller, the microcontroller to receive the direction input signal, to generate a direction output signal from the direction input signal that is compatible with a console controller signal type, and to send the direction output signal to the gaming console through the console controller, wherein the direction input and output signals each comprise an X-Y signal to indicate a movement in an X-Y axis as well as a velocity signal to indicate a speed at which the movement in the X-Y axis occurs.

5. The apparatus of claim 4, further comprising an output mode selector to select between a digital output mode and an analog output mode and to generate a control signal to indicate an output mode selection.

6. The apparatus of claim 5, further comprising a multiplexor coupled to the output interface and the output mode selector, the multiplexor to implement the output mode selection based on the control signal from the output mode selector, to multiplex a plurality of output signals from the output interface, and to output a multiplex output signal based on the output mode selection.

7. The apparatus of claim 6, further comprising a digital-to-analog converter coupled between the multiplexor and the output interface, wherein the direction output signal comprises a digital output signal, the digital-to-analog converter to convert the digital output signal to an analog output signal and to send the analog output signal to the multiplexor.

8. The apparatus of claim 7, wherein the input interface comprises a trigger input interface to generate a trigger input signal, wherein the output interface comprises a trigger switch, the trigger switch to receive the trigger input signal, to map the trigger input signal to the output signal of the trigger switch as a trigger output signal, and to send the trigger output signal to the gaming console through the console controller, wherein the trigger input and output signals each indicate an ON state or an OFF state.

9. The apparatus of claim 8, further comprising a hardware switch coupled between the trigger switch and the console connector and coupled to the output mode selector, the hardware switch to implement the output mode selection based on the control signal from the output mode selector, to receive an analog trigger input signal from the trigger switch, and to output a corresponding analog trigger output signal based on the output mode selection.

10. The apparatus of claim 9, wherein the hardware switch is further configured to receive an analog trigger input signal from the trigger switch, to switch the analog trigger input signal to a digital trigger output signal, and to output the digital output trigger signal based on the output mode selection.

11. A system comprising:
a console controller to connect to a gaming console and to receive an emulation signal from a secondary controller, wherein the emulation signal is compatible with a signal type of the console controller;
a console connector to connect the secondary controller to the console controller, wherein the console controller connects the secondary controller to the gaming console; and
a controller pass-thru device to replace the emulation signal from the secondary controller with a response signal and to send the response signal to the gaming console, wherein the gaming console interprets the response signal as a response to an input by a user on the console controller.

12. The system of claim 11, wherein the controller pass-thru device is further configured to receive a feedback signal from the gaming console and to send the feedback signal through the console controller to the secondary controller.

13. The system of claim 11, further comprising a controller selector coupled to the controller pass-thru device, the controller selector to select among a plurality of operating modes, wherein the plurality of operating modes comprises a first operating mode for singular operation of the secondary controller, in which user input functions of the console controller are disabled, a second operation mode for singular operation of the console controller, in which user input functions of the secondary controller are disabled, and a third operating mode for mutual operation of the console controller and the secondary controller.

14. The system of claim 13, wherein the controller selector is further configured to implement a priority between a signal generated by the console controller and the emulation signal from the secondary controller, wherein the controller pass-thru device is further configured to send the emulation signal to the gaming console and to discard the signal type of the console controller.

15. A method comprising:
connecting a secondary controller to a console controller, wherein the secondary controller connects to a gaming console through the console controller;
generating an input signal at the secondary controller;
generating an output signal from the input signal; and
sending the output signal from the secondary controller through the console controller to the gaming console.

16. The method of claim 15, further comprising:
selecting a first profile stored in a memory device;
generating a first profile signal based on the first profile;
sending the first profile signal to an output interface, wherein the first profile signal indicates a first mapping of the output signal to a first output line; and
sending the output signal to the console controller over the first output line according to the first mapping of the first profile.

17. The method of claim 16, further comprising:
switching on demand from the first profile to a second profile stored in the memory device;
generating a second profile signal based on the second profile;
sending the second profile signal to the output interface, wherein the second profile signal indicates a second mapping of the output signal to a second output line; and
sending the output signal to the console controller over the second output line according to the second profile.

18. The method of claim 15, further comprising:
generating a direction input signal and a trigger input signal, wherein the input signal comprises the direction and the trigger input signals;
generating a direction output signal from the direction input signal that is compatible with a console controller signal type;
mapping the trigger input signal to an output of the trigger switch as a trigger output signal;
sending the direction output signal over a direction output line to the gaming console through the console controller, wherein the direction input and output signals each comprise an X-Y signal to indicate a movement in an X-Y axis as well as a velocity signal to indicate a speed at which the movement in the X-Y axis occurs; and
sending the trigger output signal over a trigger output line to the gaming console through the console controller, wherein the trigger input and output signals each indicate an ON state or an OFF state.

19. The method of claim 15, further comprising:
selecting an analog output mode;
generating a control signal to indicate the analog output mode;
converting a digital direction output signal to an analog direction output signal;
multiplexing a plurality of direction output signals from a microcontroller to a console connector according to the analog output mode; and
passing an analog trigger input signal from a trigger switch to the console connector.

20. The method of claim 18, further comprising:
selecting a digital output mode;
generating a control signal to indicate the digital output mode;
passing a digital direction output signal to a multiplexor;
multiplexing a plurality of direction output signals from the microcontroller to the console connector according to the digital output mode;
switching an analog trigger input signal from a trigger switch to a digital trigger output signal; and
sending the digital trigger output signal to the console connector.
